(19) United States
(12) Patent Application Publication
(10) Pub. No.: US 2012/0005867 A1
(43) Pub. Date: Jan. 12, 2012

(54) Multi-Purpose Adjustable Retaining Device

(76) Inventor: Jamie D. Whaley, Bowie, TX (US)

(21) Appl. No.: 13/176,806

(22) Filed: Jul. 6, 2011

Related U.S. Application Data
(60) Provisional application No. 61/399,175, filed on Jul. 8, 2010.

(51) Int. Cl. F16B 5/06; F16B 5/00

(52) U.S. Cl. 24/302

(57) ABSTRACT

A multi-purpose adjustable retaining device comprising: at least one cord having a length; at least two attachment means for affixation to an article to be retained, each attachment means fastened to a point along the length of a cord with a distance between them; and at least one adjustment means for changing the length of cord between at least two attachment means. The cord may be an elastic cord having a circular cross-section, and the adjustment means comprising a cord lock adapted to slidingly engage the cord and to release its engagement by a spring-loaded push button mechanism. Clips having a spring-activated mechanism may be used for affixation to the article. The clip may further have a closure means for securely retaining the clip in gripping engagement with an article. In one embodiment, the cord comprises an elastic cord having a circular cross-section, the attachment means comprising hook and loop fastener with one part affixed to the cord and the other part affixed to the article, the adjustment means comprising a cord lock adapted to slidingly engage the cord and to release its engagement by a spring-loaded push button mechanism.

### CROSS-REFERENCE TO RELATED APPLICATIONS

This application follows related provisional patent application No. 61/399,175 filed on Jul. 8, 2010.

### SUMMARY OF THE INVENTION

The invention relates to the field of retaining articles in place. More particularly, the invention relates to the field of retaining material such as bed sheets, tarps, table cloths, or similar articles in place.

It is well known that bed coverings do not always stay in place. Due to the different types, styles and shapes of bedding, coverings do not have a tight fitting and may require some type of retaining device to ensure proper fit. The present invention solves the problem of bed clothing/coverings not being retained properly on a bed or related problems regarding covering other objects with, for example, a tarp.

Prior art devices had non-adjustable elastic straps with small non-locking garter-type clips attached to each end. Installation required the mattress being lifted at each corner so that the strap could be installed farther in, where it would be stretched tight. The garter-type clips on the strap were difficult to attach to the sheets. The fabric would slide out of the clips and, it took many attempts to make them stay in place. Additionally, prior art devices required lifting of the mattress or required straight edges of a mattress to be functional. Similar problems were encountered with prior art devices intended to keep table cloths in place against the forces of wind or other factors.

Elastic bungee cords typically have one plastic-coated metal hook at each end. They are not built with the ability to adjust. Users have traditionally adjusted them, as needed, by tying knots in the bungee cord to decrease its length. This solution is functional, but the knots often become bound up and are not able to be undone. Additionally, the limited range of attachment means available for bungee cords limit their utility.

The present invention addresses the foregoing issues. The invention is a multi-purpose adjustable retaining device comprising: at least one cord having a length; at least two attachment means for affixation to an article to be retained, each attachment means fastened to a point along the length of a cord with a distance between them; and at least one adjustment means for changing the length of cord between at least two attachment means. The cord may be an elastic cord having a circular cross-section, and the adjustment means comprising a cord lock adapted to slidingly engage the cord and to release its engagement by a spring-loaded push button mechanism.

Clips having a spring-activated mechanism may be used for affixation to the article. The clip may further have a closure means for securely retaining the clip in gripping engagement with an article. In one embodiment, the cord comprises an elastic cord having a circular cross-section, the attachment means comprising hook and loop fastener with one part affixed to the cord and the other part affixed to the article, the adjustment means comprising a cord lock adapted to slidingly engage the cord and to release its engagement by a spring-loaded push button mechanism.

Numerous uses exist for the present invention. For example, in transporting a utility four-wheeler, there may be a need to attach a gas can to the back of the four-wheeler. A prior art bungee cord may be too long to provide the tension required to retain it properly. Previously, the only way to adjust it was to tie a knot in the cord. However, using the present invention, the gas can may easily and securely be affixed in place with just the right length of cord.

The invention may be used for holding a cover on a car, motorcycle, power sport equipment, boat, grills, outdoor furniture, lawn equipment, air conditioners and the like. The invention may also be used for holding blankets covering infant car seat or stroller. Generally, the car seat is covered, and the infant can not be seen. The invention allows for the attachment of the blanket with the blanket opening in the front, so that a view of the infant is maintained. The invention may be used to hold the cords together neatly behind the desk. With the release of the cord stop, a user can increase or decrease the number of cords being retained. Other potential uses include holding seat covers in place, whether in a building or in a vehicle. The present invention is useful in crafts, for example, in holding items in place while glue or other bonding agents are drying. One skilled in the art could easily see that the present invention would be useful in a wide variety of applications including the foregoing specific applications and others like those mentioned.

There have thus been outlined, rather broadly, the more important features of the invention in order that the detailed description thereof that follows may be better understood, and in order that the present contribution to the art may be better appreciated. There are, of course, additional features of the invention that will be described hereinafter and which will form the subject matter of the claims appended hereto.

In this respect, before explaining at least one embodiment of the invention in detail, it is to be understood that the invention is not limited in this application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting. As such, those skilled in the art will appreciate that the conception, upon which this disclosure is based, may readily be utilized as a basis for the designing of other structures, methods and systems for carrying out the several purposes of the present invention. Additional benefits and advantages of the present invention will become apparent in those skilled in the art to which the present invention relates from the subsequent description of the preferred embodiment and the appended claims, taken in conjunction with the accompanying drawings. It is important, therefore, that the claims be regarded as including such equivalent constructions insofar as they do not depart from the spirit and scope of the present invention.

Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application. The abstract is neither intended to define the invention of the application which is measured by the claims, nor is it intended to be limiting as to the scope of the invention in any way.

### DESCRIPTION OF THE DRAWINGS

FIG. 1 is a first embodiment of the invention with dual closed loops.

FIG. 2 is a second embodiment with a closed second loop and an open operational loop.

FIG. 3 shows an embodiment of the invention using multiple cords to retain an article such as a bed sheet in place.

FIG. 4 shows a third embodiment with open operational legs and non-operational legs.

FIG. 5 shows the invention in use to retain a bed sheet in place.

### DETAILED DESCRIPTION OF THE INVENTION

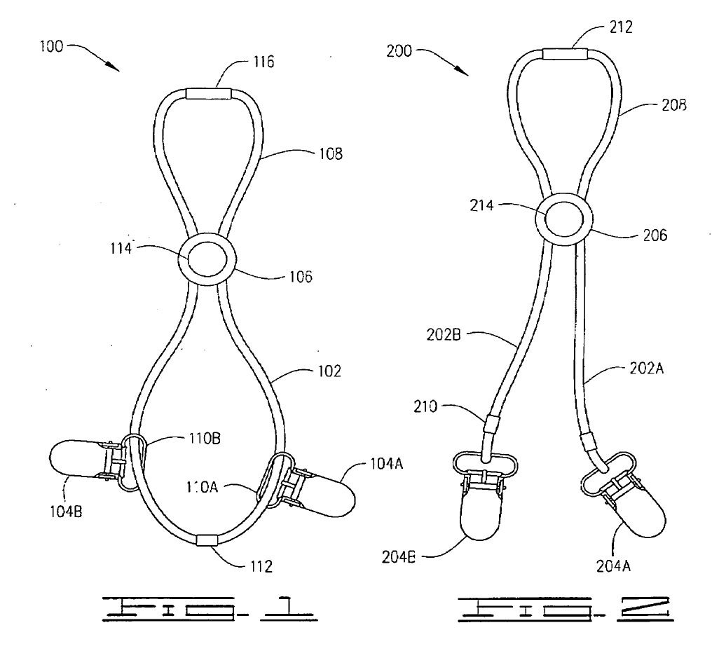

FIG. 1 shows an embodiment of a multi-purpose adjustable retaining device 100 having a cord defining a closed loop. An operational loop 102 is defined by an adjustment means 106, as shown, a cord lock, is adapted to slidingly engage the cord and to release its engagement by a spring-loaded, push-button mechanism through which the two pieces of the cord pass. The cord lock has a button 114 which causes it to disengage allowing the cords passing therethrough to be adjusted. Slidingly affixed inside of the operational loop 102 by two sliding engagement points 110A and 110B are two clips, 104A and 104B. As the adjustment means 106 is used to decrease the amount of cord in the operational loop 102, more cord is passed into the second loop 108. Conversely, as the adjustment means 106 is used to increase the amount of cord in the operational loop 102, cord passes from the second loop 108 into the operational loop 102. The device is shown with optional grip points 112 and 116 affixed to the cord.

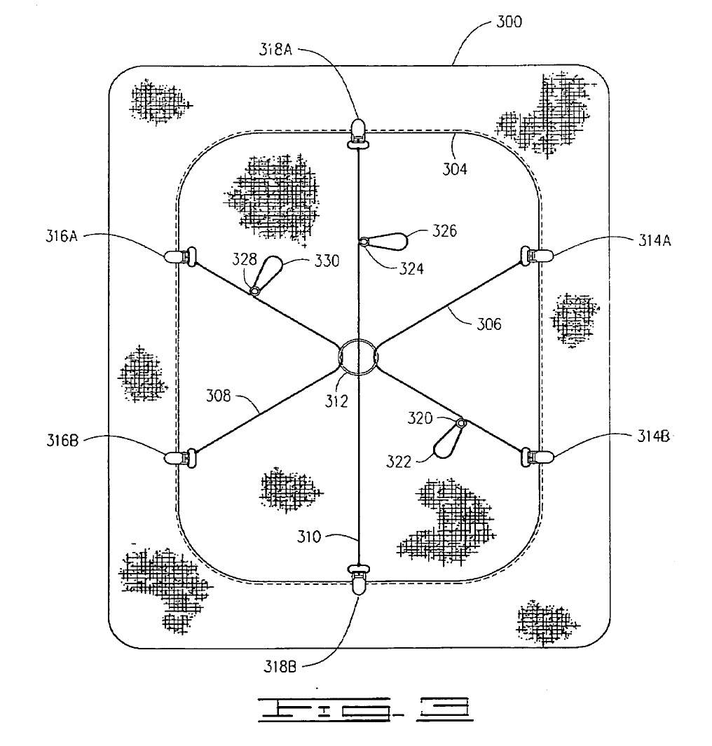

FIG. 2 shows an embodiment related to FIG. 1., but the embodiment in FIG. 2 does not have a closed operational loop 102. Instead, the configuration shown in FIG. 2 has two operational legs 202A and 202B. A clip, 204A and 204B is affixed to an end of each of the operational legs by a knot 210. The cord lock 206 with a release button 212 allows the length of the operational legs to be adjusted. As shown, a second loop 208 is formed by the cord not a part of the operational legs, and a grip point 212 is provided.

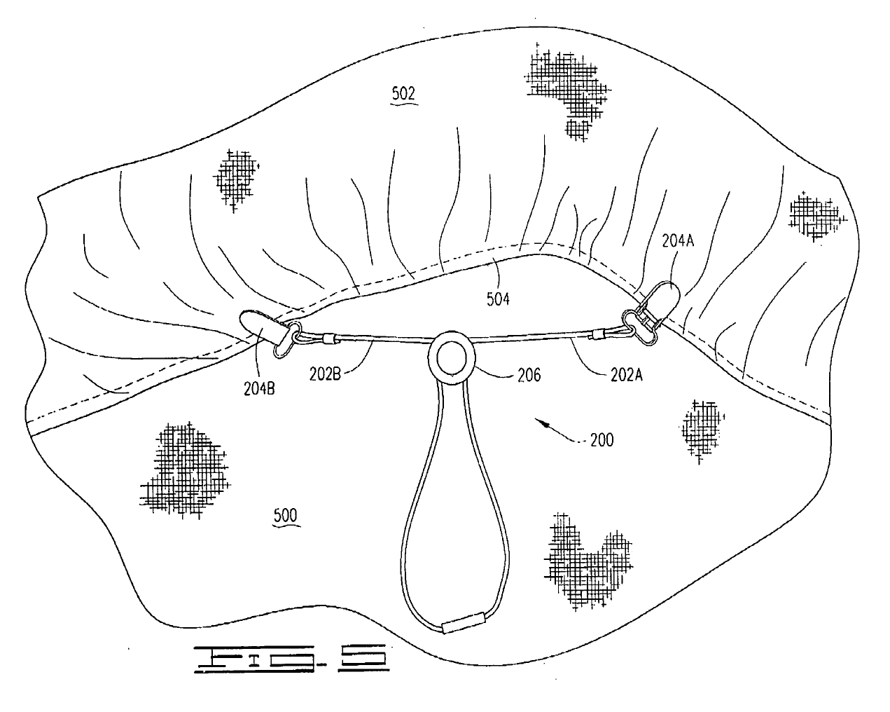

Alternatively, the second loop 208 need not be closed, but could rather be cut into two pieces as shown in FIG. 4. Similar components are shown in FIG. 4, such as a first and second operational leg 402 and 404 having at an end thereof clips 405 and 408. The cord lock 410 with release button 412 is shown. Instead of a second loop 208, however, the device in FIG. 4 has a first and second non-operational leg 412 and 414. Optional end caps 416 and 418 are shown at terminal ends of the non-operational legs. The end caps may prevent fraying and, where their cross-section (as shown) is larger than the cross-section of the cord, they also prevent the terminal ends of the non-operational legs 412 and 414 from passing through the cord lock 410, thus preventing unintentional dis-assembly of the device.

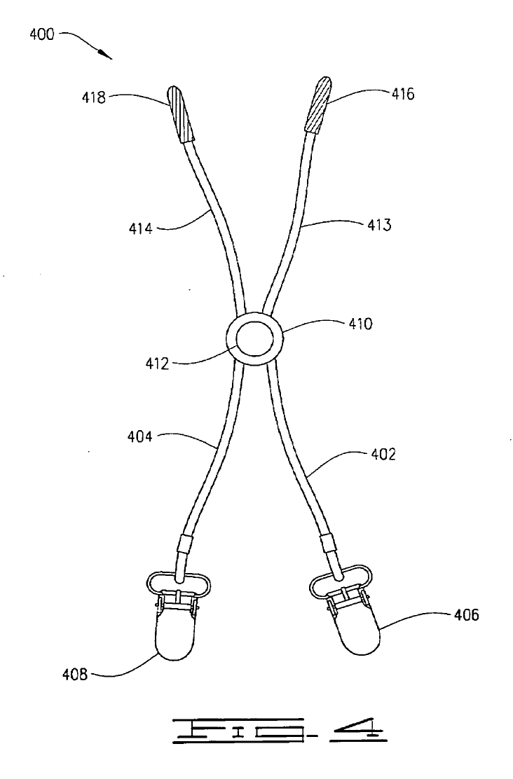

Use of multiple cords for retaining a sheet or tarp is shown in FIG. 3. This embodiment is shown affixed to a bed sheet 300 having an inner ring 304. However, instead of a bed sheet, it could be affixed to a tarp covering a car or other item, a tablecloth on a table, or other similar items. Three cords 306, 308, and 310 intersect at a central ring 312. As shown, the cords can slidingly move through the ring, allowing for easy adjustment of them relative to one another and to the bed sheet 300. The could, however, be fixedly attached to one another at the central point. Each cord is shown with attachment clips at their terminal ends, 314A and 314B on cord 306; 316A and 316B on cord 308; and 318A and 318B on cord 310. Each cord is also shown with a single adjustment means, 320, 324, and 328. For each adjustment means, a second loop of cord exists, 322, 326, and 330, respectively. Thus, as shown, a bed sheet 300 can be securely retained in place and can be prevented from sliding or coming disengaged. It can be seen that cord 310 can be removed from this configuration, and the device will still retain the bed sheet in place. Alternatively, more cords could be added for more secure retention of the sheet or similar article in a desired position.

FIG. 5 shows the device 200 in use to retain a bed sheet 502 in place over a mattress 500. The clips 204A and 204B are affixed to an inner ring 504 of the bed sheet 502. The cord lock 206 is used to adjust the operational legs 202A and 202B to securely engage the length of cord between them to hold the bed sheet 502 in place.

The cord used may be a bungee cord with a circular cross-section or generally any type of elastic band. Other materials that may be used include nylon, plastic, rubber, string, or any other material. Cord may be one/two cords of various lengths, diameters or measurements. Preferably, the cord will have at least some elasticity, but in certain applications, a fixed cord length may be desirable, so, in those instances, a non-elastic cord may be used.

The adjustment means may be a cord lock of the type defining at least one passage therethrough and adapted to releasably engage a cord by operation of a spring-loaded release button. Cord lock devices may be obtained in many configurations, some of which have a button-like appearance, and others which have a barrel shape. Similarly, there are cord lock devices with multiple passages therethrough to receive two or more cords. Any of the commercially available cord lock devices may be appropriate for use with the present invention.

The attachment means may be selected from the group of a clamp, clasp, clip, hook, hook and loop fastener, button, magnet, pin, clip or other similar connection device. If a clip is used, it may be either spring-loaded, or it may have a releasable locking mechanism. Alternatively, the clip may have both a spring-loaded action and a supplemental locking mechanism.

The attachment means may be affixed to the cord by a quick-change means. The quick-change means may be as simple as a carabiner or clip to engage an eye on the attachment means. Alternatively, it may be a spring-loaded engagement mechanism, similar to those used in air chuck systems.

For preventing the ends of the cord from raveling and protecting them from damage end caps comprised of a metal fitting securely engaging the cord, a crimp tube, plastic tie, ferrule, heat shrink tube, clasp or any other similar device may be used. The cross section of the end cap may be larger than the cross-section of the cord, thus, the cord may be prevented from coming out of the cord lock as the larger end cap will not pass therethrough. Similarly, the grip points may be comprised of similar materials to the end cap. The grip point gives a user of the device a point to hold grasp to cord more securely when adjustments are being made to tighten or loosen device.

In operation, the invention is installed on an apparatus to be retained by affixing the attachment means to the article at desired locations. The user presses the button on the cord lock to release the cords while using the other hand to pull cord to achieve desired tightness. Once the desired tension is obtained, the user releases the button on the cord lock to retain the article in place. Remaining cord may be tucked under the article for a neater appearance. Removal involves simply pressing the button on cord lock while pulling to loosen cord followed by release of the attachment devices.

The purpose of the abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application. The abstract is neither intended to define the invention of the application which is measured by the claims, nor is it intended to be limiting as to the scope of the invention in any way.

While the invention has been shown, illustrated, described and disclosed in terms of specific embodiments or modifications, the scope of the invention should not be deemed to be limited by the precise embodiment or modification therein shown, illustrated, described or disclosed. Such other embodiments or modifications are intended to be reserved especially as they fall within the scope of the claims herein appended.

Having thus described the invention, I claim:

1. A multi-purpose adjustable retaining device comprising:
a. at least one cord having a length;
b. at least two attachment means for affixation to an article to be retained, each attachment means fastened to a point along the length of cord with a distance between them;
c. at least one adjustment means for changing the length of cord between at least two attachment means.

2. The device of claim 1, the cord comprising an elastic cord having a circular cross-section, the attachment means comprising hooks, the adjustment means comprising a cord lock adapted to slidingly engage the cord and to release its engagement by a spring-loaded push button mechanism.

3. The device of claim 1, the cord comprising an elastic cord having a circular cross-section, the attachment means comprising clips, the adjustment means comprising a cord lock adapted to slidingly engage the cord and to release its engagement by a spring-loaded push button mechanism.

4. The device of claim 3, the clip comprising a spring-activated clip for compressing affixation to the article.

5. The device of claim 4, the clip having a closure means for securely retaining the clip in gripping engagement with the article.

6. The device of claim 1, the cord comprising an elastic cord having a circular cross-section, the attachment means comprising hook and loop fastener with one part affixed to the cord and the other part affixed to the article, the adjustment means comprising a cord lock adapted to slidingly engage the cord and to release its engagement by a spring-loaded push button mechanism.

7. A multi-purpose adjustable retaining device comprising:
a. at least one cord having a length;
b. at least two attachment means for affixation to an article to be retained, each attachment means slidingly engaging a cord inside of a loop;
c. at least one adjustment means for changing the length of cord comprising the loop.

8. The device of claim 7, the cord comprising an elastic cord having a circular cross-section, the attachment means comprising hooks, the adjustment means comprising a cord lock adapted to slidingly engage the cord and to release its engagement by a spring-loaded push button mechanism.

9. The device of claim 7, the cord comprising an elastic cord having a circular cross-section, the attachment means comprising clips, the adjustment means comprising a cord lock adapted to slidingly engage the cord and to release its engagement by a spring-loaded push button mechanism.

10. The device of claim 7, the clip comprising a spring-activated clip for compressing affixation to the article.

11. The device of claim 10, the clip having a closure means for securely retaining the clip in gripping engagement with the article.

12. The device of claim 7, the cord comprising an elastic cord having a circular cross-section, the attachment means comprising hook and loop fastener with one part affixed to the cord and the other part affixed to the article, the adjustment means comprising a cord lock adapted to slidingly engage the cord and to release its engagement by a spring-loaded push button mechanism.

13. A multi-purpose adjustable retaining device comprising:
a. at least two cords, each having a length, the cords intersecting at a point;
b. at least two attachment means for affixation to an article to be retained on each cord;
c. each cord having an adjustment means for changing the length of cord between at least two attachment means;
d. intersection means for engaging the cords at an intersection point;
whereby, sides of the article can be simultaneously retained in place.

14. The device of claim 13 further having a third cord also intersecting at the point, the third cord also having at least to attachment means for affixation to the article and an adjustment means for changing the length of cord between the attachment means, whereby an article can be even more securely retained.

15. The device of claim 14, the intersection means comprising a ring through which cords can be slidingly passed.

16. A multi-purpose adjustable retaining device comprising:
a. at least one cord having a length;
b. at least two attachment means for affixation to an article to be retained, each attachment means fastened to a point along the length of cord with a distance between them;
c. at least one adjustment means for changing the length of cord between at least two attachment means; and
d. quick-change means adapted to allow for various attachment means to be interchangeably affixed to the cord.

17. The device of claim 16, the attachment means selected from the group comprised of a clamp, clasp, clip, hook, hook and loop fastener, button, magnet, pin, or clip.
